(19) United States
(12) Patent Application Publication
(10) Pub. No.: US 2025/0190856 A1
(43) Pub. Date: Jun. 12, 2025

(54) TAILORED RECOMMENDATION FOR PROCESS CONTROL

(71) Applicant: International Business Machines Corporation, Armonk, NY (US)

(72) Inventors: Pankaj Satyanarayan Dayama, Bangalore (IN); Arindam Jati, Bengaluru (IN); Sumanta Mukherjee, Bangalore (IN); Kameshwaran Sampath, Bengaluru (IN); Chandramouli Kamanchi, Guntur District (IN)

(21) Appl. No.: 18/536,971

(22) Filed: Dec. 12, 2023

(51) Int. Cl. G06N 20/00

(52) U.S. Cl. CPC G06N 20/00

(57) ABSTRACT

Systems/techniques that facilitate tailored recommendation for process control by capturing real-time operation practices are provided. In various embodiments, a system can comprise a learning component that can employ a VQ-VAE based generative model to learn correlated patterns of state and control variables. In various embodiments, the system can further comprise a training component that can generate, based on the learned correlated patterns, feasible and infeasible action profiles to produce an infeasible and feasible system response. Furthermore, the feasible action profiles and system responses can be used with an infeasible action penalty to train a surrogate model, from which an analysis component can use to provide a recommendation of feasible and optimal set points of control variables.

### BACKGROUND

The subject disclosure relates to process control and, more specifically, to tailored recommendation for process control by capturing real-time operation constraints.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable tailored recommendation for process control.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a training component that utilizes action trajectories to train a local action surrogate model that integrates an infeasible action penalty. The computer executable components can further comprise an analysis component that employs the local action surrogate model in process control optimization formulation to provide a recommendation of set points.

According to another embodiment, a computer-implemented method is provided. The computer-implemented method can comprise utilizing, by a system operatively coupled to a processor, action trajectories to train a local action surrogate model that integrates an infeasible action penalty. The computer-implemented method can further comprise employing, by the system, the local action surrogate model in process control optimization formulation to provide a recommendation of set points.

According to yet another embodiment, a computer program product for facilitating tailored recommendation for process control is provided. The computer program product can comprise a computer readable storage medium having program instructions embodied therewith, the program instructions executable by a processor to cause the processor to utilize action trajectories to train a local action surrogate model that integrates an infeasible action penalty and employ the local action surrogate model in process control optimization formulation to provide a recommendation of set points.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate tailored recommendation for process control in accordance with one or more embodiments described herein.

FIG. 2 illustrates a block diagram of an example, non-limiting system that can facilitate tailored recommendation for process control in accordance with one or more embodiments described herein.

FIG. 3 illustrates an example, non-limiting representation of tokenization of time series with a VQ-VAE based generative model in accordance with one or more embodiments described herein.

FIG. 4 illustrates an example, non-limiting representation of generating or sampling a time series with a VQ-VAE based generative model in accordance with one or more embodiments described herein.

FIG. 5 illustrates an example, non-limiting representation of forecasting state variables with a complex AI model in accordance with one or more embodiments described herein.

FIG. 6 illustrates an example, non-limiting representation of training a local action surrogate model with an infeasible action penalty in accordance with one or more embodiments described herein.

FIG. 7 illustrates a block diagram of an example, non-limiting system 700 that can facilitate tailored recommendation for process control in accordance with one or more embodiments described herein.

FIG. 8 illustrates a flow diagram of an example, non-limiting method 800 of facilitating tailored recommendation for process control in accordance with one or more embodiments described herein.

FIG. 9 illustrates a flow diagram of an example, non-limiting method 800 of facilitating tailored recommendation for process control in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Plant or industrial processes (e.g., metal production, mining, electronic device assembly, concreate production) are typically complex processes that are monitored by a multitude of sensors to collect data that can be used to optimize process control or key performance indicators (e.g., minimize energy usage, maximize production, minimize cost). Control (e.g., action) variables are aspects of the process that can be controlled by a process operator (e.g., amount of material used, gas flow rates, pressure levels). State variables are aspects of equipment or a process that are not directly controlled and results from a set of control variables. Typically, regression optimization on the control and state variables can be used to optimize these processes by determining optimal set points of control variables to achieve a desired optimization goal (e.g., minimum energy usage and maximum material production).

However, methods of process optimization face various challenges. Current methods of process optimization can frequently generate a recommendation of set points that an operator is not physically able to implement or is infeasible to implement. In other words, an operator may not be capable of executing the optimal set points for a determined lookahead horizon due to inherent process limitations. For example, a generated recommendation of set points can be suggested to the process operator that requires the operator to alternately increase and decrease an oxygen flow rate every five minutes. Such a recommendation can be impractical to implement although it achieves an optimal solution. As another example, a recommended optimal set points can suggest a rate of production that exceeds capacity of available machinery or personnel. Such a recommendation fails to satisfy personnel or resource constraints and therefore cannot be implemented to optimize process control. Thus, the recommendation of optimal set points in both examples is rendered useless or ineffective.

Moreover, methods of process optimization fail to satisfy or accommodate dynamic business requirements. Changing operation constraints can cause difficulty in optimization formulation as it is challenging to consistently update optimization formulation according to the changing real-time business requirements and accordingly deploy the optimal solution. For example, market dynamics, customer preferences, or external factors may affect business requirements on an industrial process. Furthermore, continuous updating of optimization formulation can involve adjusting numerous parameters or constraints due to complexities of process control.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate tailored recommendation for process control. That is, various disadvantages associated with existing techniques for process control can be ameliorated by tailored recommendation for process control by capturing real-time operation constraints.

In various embodiments, a learning component can learn correlated patterns of state and control variables by tokenizing time series data or forecasting state variables. The learning component can employ a vector quantized variational autoencoder (VQ-VAE) based generative model to learn the correlated patterns from historical data. Thus, a training component can generate, based on the learned correlated patterns, feasible and infeasible action profiles to produce an infeasible and feasible system response from a complex AI model. Furthermore, the feasible action profiles and system responses can be used with an infeasible action penalty to train a surrogate model, wherein the infeasible action penalty is included on infeasible system responses to penalize infeasible action profiles in the surrogate model. Moreover, an analysis component can use the trained surrogate model that penalizes infeasible action profiles to provide a recommendation of feasible and optimal set points of control variables for process optimization. Therefore, process optimization can be automated, enable adaption to dynamic business requirements, and provide practical optimal solutions.

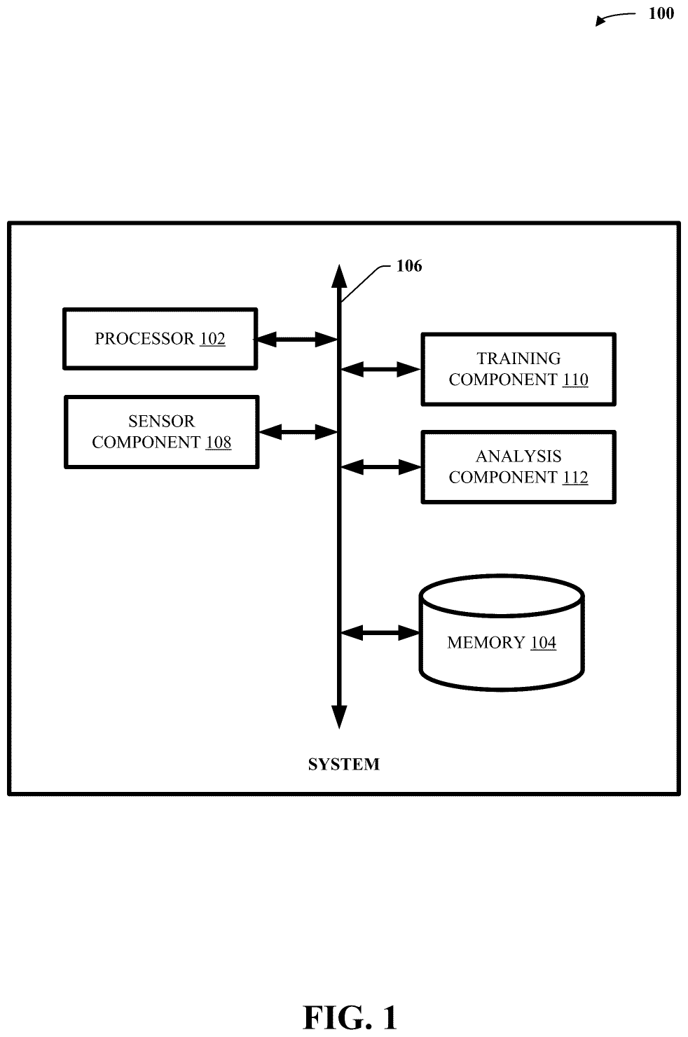

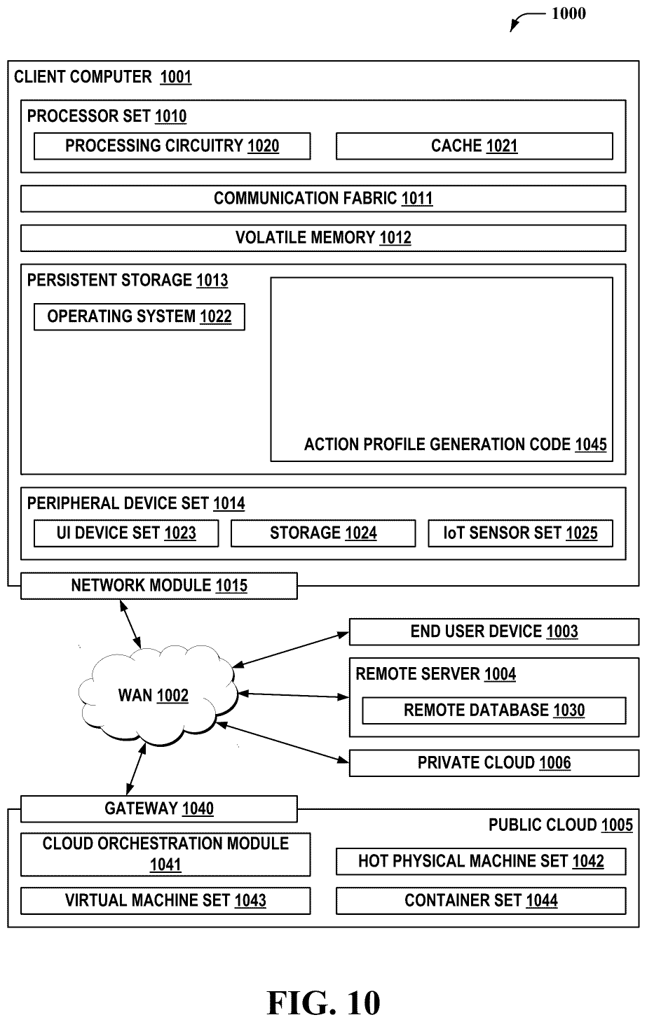

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated in FIG. 10. For example, system 100 can be associated with, such as accessible via, a computing environment 1000 described below with reference to FIG. 10, such that aspects of processing can be distributed between system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can facilitate tailored recommendation for process control in accordance with one or more embodiments described herein. System 100 can comprise processor 102, memory 104, system bus 106, sensor component 108, training component 110, and analysis component 112.

The system 100 and/or the components of the system 100 can be employed to use hardware and/or software to solve problems that are highly technical in nature (e.g., surrogate model training, regression optimization, etc.), that are not abstract and that cannot be performed as a set of mental acts by a human. Further, some of the processes performed may be performed by specialized computers for carrying out defined tasks related to tailored recommendation of process control. The system 100 and/or components of the system can be employed to solve new problems that arise through advancements in technology, computer networks, the Internet and the like. The system 100 can provide technical improvements to generating feasible set point recommendations, adaptation to dynamic business requirements in process control, and/or automation of process control, etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., sensor component 108, training component 110, and/or analysis component 112) to perform one or more actions. In one or more embodiments, memory 104 can store computer-executable components (e.g., sensor component 108, training component 110, and/or analysis component 112).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, the training component 110 can train a surrogate model with generated compliant action profiles, system responses of action profiles from a complex AI model, and an infeasible action penalty. Thus, the analysis component 112 can use the trained surrogate model in regression optimization to generate a recommendation of feasible and optimal set points. Additional aspects of the one or more embodiments discussed herein are explained in greater detail with reference to subsequent figures. System 100 can be associated with, such as accessible via, a computing environment 1000 described below with reference to FIG. 10. For example, system 100 can be associated with a computing environment 1000 such that aspects of processing can be distributed between system 100 and the computing environment 1000.

In various embodiments, the sensor component 108 can obtain, via any suitable sensors, process data. In various aspects, the sensor component 108 can obtain process data that can comprise any suitable data on equipment or systems of equipment (e.g., temperature data from a temperature sensor, pressure data from a pressure sensor). In various cases, the sensor component 108 can obtain the process data in fixed time intervals. In other words, the process data can comprise sequential observations indexed by time stamps in time order. Therefore, the process data can be historical data structured as a time series. In various cases, the process data can exhibit any suitable size or dimensionality (e.g., any suitable number of variables). Furthermore, the process data can comprise data on state variables or control (e.g., action) variables. In various aspects, state variables can describe a state of the system or process that can not be manually controlled (e.g., temperature of a created metal). In various instances, control variables can describe variables of the system or process that can be controlled (e.g., oxygen flow rate in a burner to create the metal).

In various aspects, the sensor component 108 can be various internal or external sensors (e.g., flow meters, pressure sensors, temperature sensors, power meters, photodetectors, strain gauges, gas sensors). In various aspects, the sensor component 108 can utilize such sensors to capture process data of equipment or system of equipment utilized in, for example, an industrial or plant process (e.g., to measure flow rates of fluids in pipes, to measure pressure changes in hydraulic systems, to measure temperature of equipment, to measure electrical power consumption). For example, the sensor component 108 can measure pressure levels in pipelines to ensure optimal pressure levels are utilized. Thus, the analysis component 112 can access such sensor data to optimize process control and provide a recommendation of set points.

In various embodiments, the training component 110 can utilize the time series data (e.g., process data, historical data) to include dynamic constraints (e.g., business requirements) in real-time to ensure that a recommendation of set points, provided by the analysis component 112, are feasible (e.g., able to practically implement). For example, a constraint can be a maximum value of temperature of a created metal based on quality standards. Thus, the training component 110 can use time series data on metal temperature and various control variables, such as oxygen flow rate, to learn this constraint and enable the analysis component 112 to generate a feasible set point recommendation of control variables that does not violate this constraint.

In various embodiments, as described herein, the training component 110 can utilize action trajectories to train a local action surrogate model that integrates an infeasible action penalty. In various cases, the action trajectories can be compliant (e.g., feasible) or non-compliant (e.g., infeasible). More specifically, action profiles can contain a set of control variables with forecasted values that can be compliant or non-compliant. Compliant action profiles indicate that the forecasted control variables are feasible. Conversely, non-compliant action profiles indicate that the control variables are not feasible (e.g., not practical to implement, impossible to implement). In various aspects, compliant action trajectories can be generated, as described herein, by a vector quantized variational autoencoder (VQ-VAE) based generative model on the historical data.

In various embodiments, the generated action profiles can be provided to an artificial intelligence (AI) model (e.g., multivariate forecasting model) to generate two types of system response (e.g., output). In other words, the complex AI model is used for multivariate time series forecasting of state variables. The system response can be forecast values for state variables. One type of system response can be generated if the control variables are compliant, and a second type of system response can be generated if the control variables are non-compliant, wherein system responses generated from non-compliant variables include an infeasible action penalty (e.g., penalty function, penalty parameter). Therefore, in various embodiments, the training component 110 can use the generated action profiles as input and generated system responses as targets to train the local action surrogate model.

In various embodiments, as described herein, the analysis component 112 can employ the local action surrogate model in process control optimization formulation to provide a recommendation of set points. In various aspects, the local action surrogate model takes the action profiles as input to predict an output of the complex AI model. That is, the pair of action profiles and system responses acts as a training dataset for the local action surrogate model, from which the local action surrogate model can be used in an optimization system to provide optimal set points of control variables.

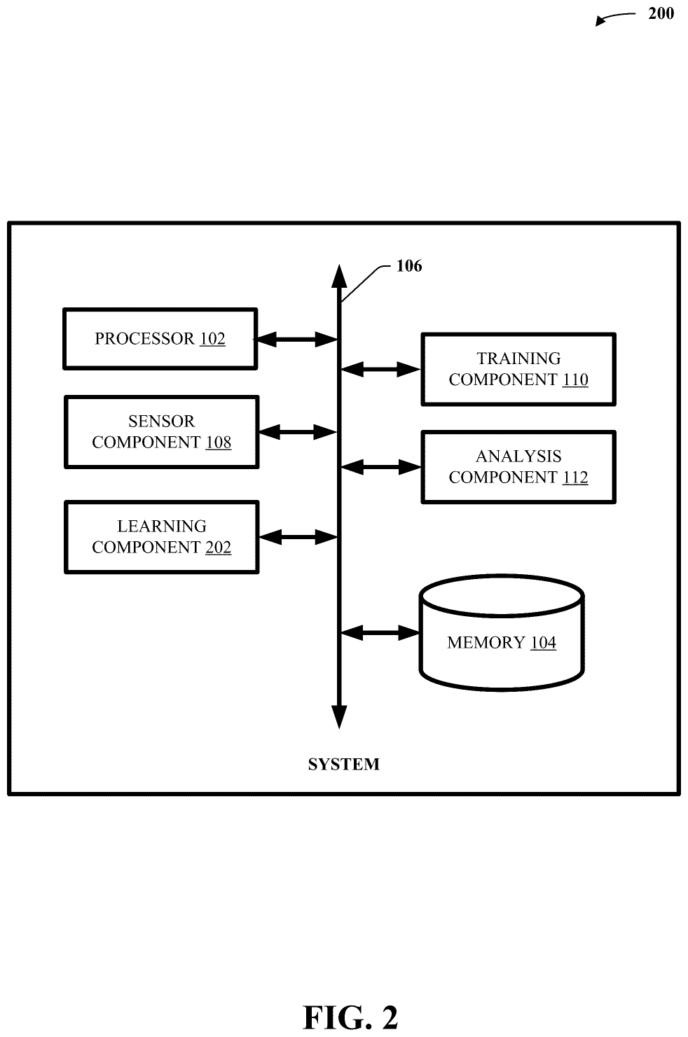

FIG. 2 illustrates a block diagram of an example, non-limiting system 200 that can facilitate tailored recommendation for process control in accordance with one or more embodiments described herein. As shown, the system 200 can comprise the same components as the system 100 and can, in some cases, further comprise a learning component 202.

In various embodiments, the training component 110 can engage the learning component 202 to generate the action trajectories by learning patterns of correlated actions of historical data of a set of control variables. In various aspects, the learning component 202 can generate compliant action trajectories with the VQ-VAE based generative model. A VQ-VAE (Vector Quantized Variational Autoencoder) model is a type of neural network architecture used in machine learning and deep learning that combines elements of variational autoencoders (VAEs) and vector quantization to learn a compressed and discrete representation of input data. VAEs can comprise an encoder and a decoder. In various aspects, the encoder can compress input data (e.g., time series data) into a lower-dimensional representation. More specifically, the encoder maps the input data to a probability distribution in a latent space (e.g., a conceptual space such that each dimension represents a learned attribute) to introduce variability. Vector quantization can be employed by the encoder to generate a set of discrete codewords. In various aspects, vector quantization can create the discrete codewords by mapping continuous output of the encoder to a set of discrete values (e.g., codebook). In various instances, the decoder can reconstruct the input data from the lower-dimensional representation. In other words, the decoder generates data by sampling from the probability distribution.

In various embodiments, the learning component 202 can employ the VQ-VAE based generative model to tokenize the historical data, whish is structured as a multivariate time series, into a series of integer tokens. In various aspects, the integer tokens can represent a codeword of the codebook generated through vector quantization. In various instances, similar segments of a time series or multiple time series can be assigned the same integer token. Furthermore, tokenization of the time series is used to reduce the size of a dataset to enable correlated patterns in the historical data to be learned.

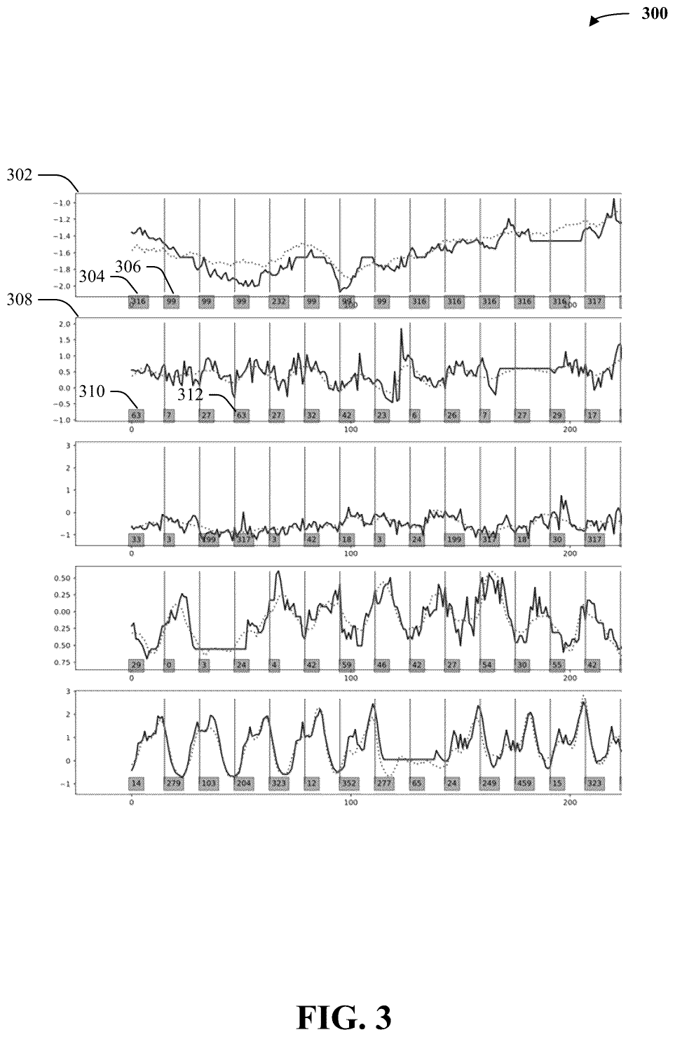

FIG. 3 illustrates an example, non-limiting representation of tokenization of time series with a VQ-VAE based generative model in accordance with one or more embodiments described herein.

In various embodiments, graphs 300 depict five time series that have been segmented into tokens wherein each token is an integer value. As previously described, the integer value assigned of a token represents a codeword in a codebook that has been learned from the historical data. As an example of tokenization of time series using the VQ-VAE based generative model, there can be a time series 302. In various aspects, the VQ-VAE based generative model can segment the time series 302 into tokens. As shown in time series 302, the first segment of the time series 302 can be identified by a token 304 and the following segment can be identified by a token 306. For example, the integer value of token 304 is 316, and the integer value of token 306 is 99. In various aspects, the remaining segments of the time series 302 are also assigned an integer token. Therefore, a vector of the integer token values can represent the entire time series, wherein an individual token represents a segment of the time series. As another example of tokenization of time series, time series 308 can be segmented and assigned integer token values to each segment. The integer value assigned to each token of the time series can be determined by the behavior of the particular segment. For instance, if two segments exhibit a similar pattern, the two segments can be assigned a same or similar integer value. For example, the first token 310 of time series 308 is assigned an integer value of 63, and the fourth token of time series 308 is assigned an integer value of 63. That is, the first token and the fourth token exhibit a similar pattern. In various aspects, assignment of similar or same token values can enable the learning component 202 to identify correlated patterns in the historical data. More specifically, the learning component 202 can use a classical algorithm such as association rule mining, enabled by segmentation and clustering of the time series, to determine significant association rules or correlated patterns in the historical data. For example, an association rule can be an increase in a control variable causes a state variable to increase (e.g., if oxygen flow rate is increased, then temperature increases). In various instances, such patterns or correlations can be observed in the historical data, from which association rule mining can be utilized to obtain these patterns or correlations.

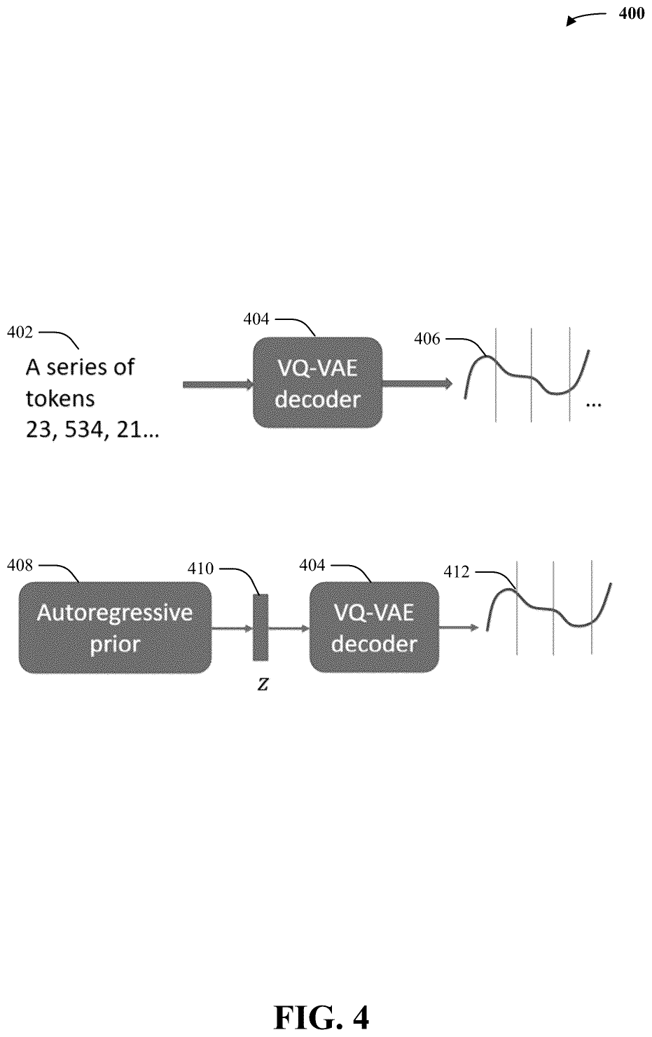

FIG. 4 illustrates an example, non-limiting representation of generating or sampling a time series with a VQ-VAE based generative model in accordance with one or more embodiments described herein.

In various embodiments, following training of the VQ-VAE based generative model, the learning component 202 can use the VQ-VAE based generative model to generate or sample another time series. In various aspects, the learning component 202 can deterministically generate another time series by concatenating a vector of tokens. In other words, the vector of tokens can be mapped to its respective time series space by the VQ-VAE decoder. For example, a series of tokens 402 wherein the first three tokens are 23, 534, and 21, can be mapped to its respective time series space by VQ-VAE decoder 404, and therefore generate time series 406. In various cases, the learning component 202 can also randomly generate another time series by training an autoregressive prior model (e.g., probabilistic model that captures dependencies within sequential data by modeling the conditional distribution of each element given its preceding elements) on the latent space and subsequently generating the time series via ancestral sampling (e.g., technique to generate samples from a probability distribution defined by a model wherein values are sequentially sampled for each variable according to its conditional distribution given the values of its parent variables until all variables are determined). For example, an autoregressive prior model 408 can be trained on latent space 410, wherein VQ-VAE decoder 404 can utilize ancestral sampling to randomly generate time series 412. Thus, the generated time series can be used as compliant action profiles as input for the complex AI model to generate system responses, from which the action profiles and system responses are used to train the local action surrogate model.

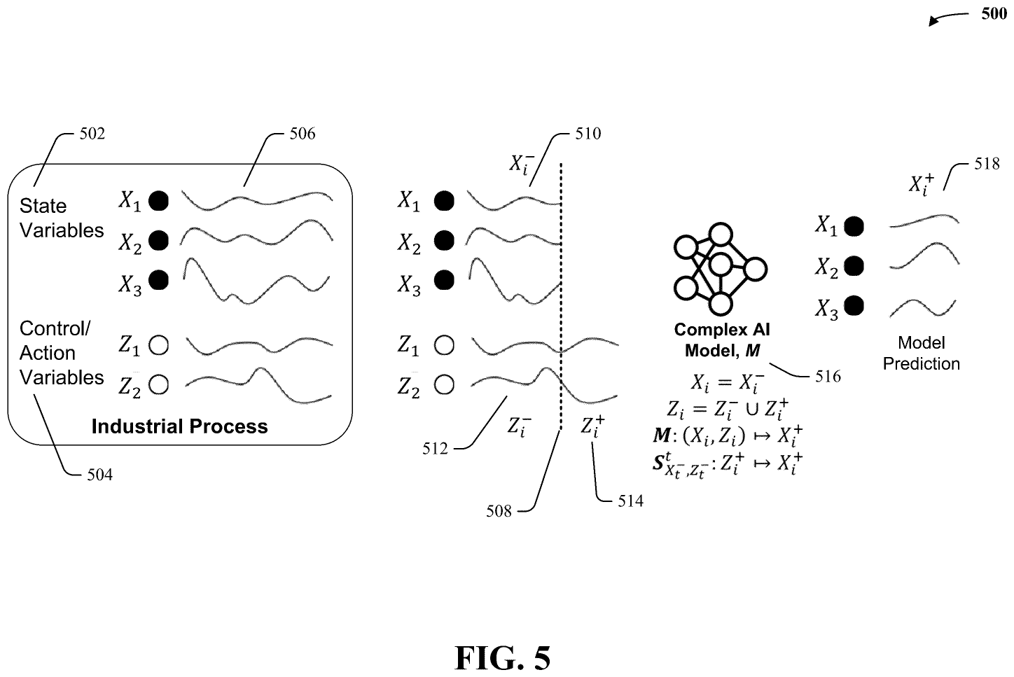

FIG. 5 illustrates an example, non-limiting representation of forecasting state variables with a complex AI model in accordance with one or more embodiments described herein.

In various aspects, an example industrial process can be monitored by measurements of three state variables 502, denoted by X₁, X₂, and X₃, and two control variables 504, denoted by Z₁ and Z₂. Time series data (e.g., historical data) on the state variables 502 and control variables 504 can be depicted at 506. Complex AI model 515, denoted by M, can be used on to compute forecast values of state variables 502. In various aspects, the complex AI model 516 can be a multivariate forecasting model that can be used in a regression optimization system to forecast values of the state variables 502. For example, present time can be represented by dotted line 508, wherein historical time series data of state variables 502, denoted by Xᵢ⁻, can be illustrated at 510 and historical time series data of control variables 504, denoted by Zᵢ⁻, can be illustrated at 512. The historical data of state variables 502 and control variables 504 can be defined up to current time 508. Future values of control variables 504, denoted by Zᵢ⁺, can be illustrated at 514. In various instances, the future values of control variables 502 can be determined by an operator of the industrial process or an optimization engine that determines future control variables for a determined amount of time. Future control variables are able to be predetermined variables because the operator, for example, is able to manually control these variables. Therefore, the complex AI model 516 can utilize the historical data Xᵢ⁻ and Zᵢ⁻, along with future data of control variables Zᵢ⁺ to compute a prediction 518, denoted by Xᵢ⁺, of state variables 502 for a lookahead horizon h (e.g., a length of time predictions are desired for). For example, the lookahead horizon can be four hours, meaning the complex AI model 516 can generate a forecast (e.g., action trajectory) over the next four hours. Furthermore, the generated action trajectory is generally a compliant (e.g., feasible) action trajectory because it is generated from the learned correlations of historical data by the VQ-VAE based generative model. Moreover, the complex AI model 516 can map such forecast data to produce optimal set points. Thus, the regression optimization framework of time series forecasting of state variables can enable feasible and optimal action profiles to process operators for implementation. For example, it can produce optimal set points for control variables 504 (e.g., Z₁ and Z₂) such that the state variables 502 reach a particular measure to achieve a desired goal (e.g., reach values that achieve a goal of minimum cost, maximum product output, or minimum energy usage).

As an example, if an industrial process involved producing cement, control variables 504 can comprise amounts of raw material to use and state variables 502 can comprise conditions of manufacturing the cement (e.g., temperature of a furnace, temperature of the cement). Furthermore, constraints or limitations can be desirable to impose by an operator such as an upper limit on heat supply. Moreover, the operator can have a desirable goal that the process is being optimized for, such as maximum cement production with minimum energy consumption. In various embodiments, the complex AI model 506 can compute a forecast of the state variables 502 (e.g., temperature of a cement manufacturing unit) based on the control variables 502 (e.g., amounts of raw materials used, heat supply). Therefore, a set point of control variables 504 can be recommended that achieve maximum cement production with minimum energy consumption, or any other desired goal of process optimization.

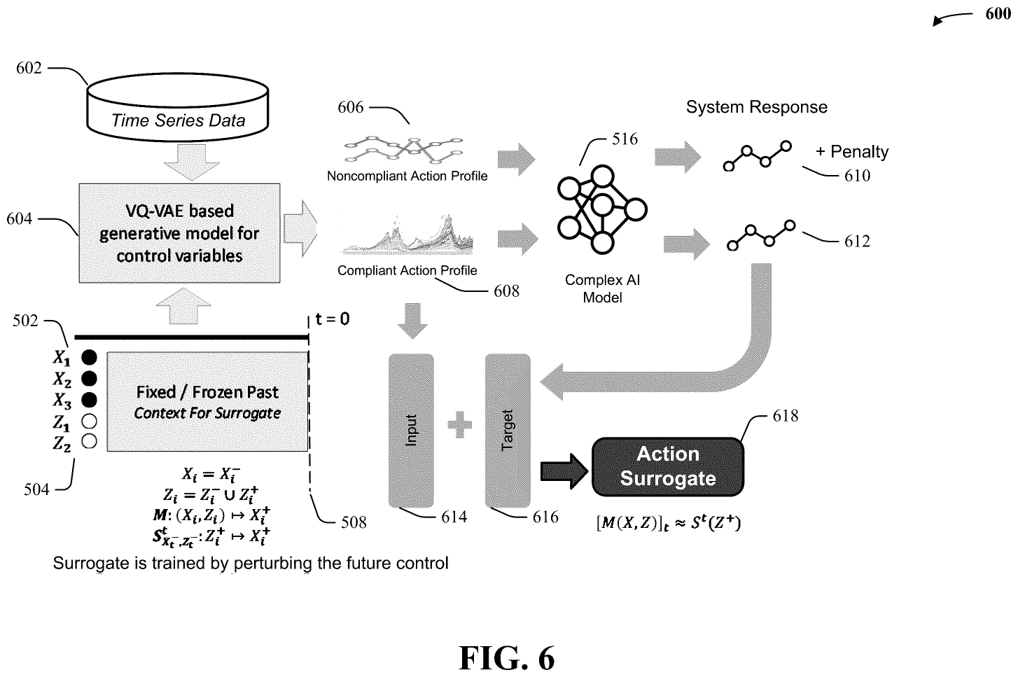

FIG. 6 illustrates an example, non-limiting representation of training a local action surrogate model with an infeasible action penalty in accordance with one or more embodiments described herein.

In various embodiments, time series data 602 can be utilized to train a VQ-VAE based generative model 604 to generate compliant action profiles 608. For example, the time series data 602 can be data collected over 10 years until a current time 508 (e.g., t=0) and can comprise historical data of state variables 502 and control variables 504. In various cases, action trajectories can be determined by perturbing future data of control variables 504 to provide context to the local action surrogate model 618. Therefore, the VQ-VAE based generative model 604 can generate compliant action profiles 608 based on learned correlations from the tokenized time series data 602. Thus, feasibility and compliance with business requirements (e.g., operation constraints) can be enforced in a recommendation of set points by leveraging the historical data to generate feasible action profiles.

In various embodiments, the training component 110 can generate non-compliant action profiles 606 by methods not limited to random simulation such that the action profile is infeasible (e.g., does not satisfy optimization constraints). More specifically, the action profile can be imposed by a set of constraints when randomly generated.

In various embodiments, the training component 110 can provide the compliant action profiles 608 and non-compliant action profiles 606 to the complex AI model 516. Therefore, the complex AI model 516 can compute a non-compliant forecast 610 and a compliant forecast 612 (e.g., non-compliant and compliant system response) respectively. More specifically, the complex AI model 516 can be provided two types of control variables 504 (e.g., compliant Z₁ and Z₂, and non-compliant Z₁ and Z₂), from which the complex AI model 516 can generate a non-compliant forecast 610 for the control variables 504 that are non-complaint and a compliant forecast 612 for the control variables 504 that are compliant.

In various aspects, the training component 110 can utilize the non-compliant forecast 610 and compliant forecast 612 as a target 616 with the compliant action profiles 608 as input to train the local action surrogate model 618. In other words, the pair of compliant action profiles 608 and system responses are used as training data for the local action surrogate model 618. Thus, the local action surrogate model 618 is not only trained to forecast on historical data like the complex AI model 516. The local action surrogate model 618 is further trained on future action profiles (e.g., Zᵢ⁺) to predict output of the complex AI model 516 by mapping Zᵢ⁺ to Xᵢ⁺. Furthermore, if the non-compliant forecast 610 is used as target 616, the training component 110 can further include an infeasible action penalty 610. In various cases, the infeasible action penalty 610 can be a penalty function, penalty term, or any suitable type of penalty measure. Therefore, the local action surrogate model 618 will have a high penalty if a non-compliant action profile is given as input. That is, system responses such that action profiles are compliant will be generated more frequently than system responses such that action profiles are non-compliant.

Moreover, the local action surrogate model 618 can be structured as a regression optimization framework by the following functions: M:(Xᵢ, Zᵢ) [symbol] Xᵢ⁺, S_{X}_{ₜ}_{^{−}}_{,Z}_{ₜ}_{^{−}}^{t}:Zᵢ⁺ [symbol] Xᵢ⁺ where Zᵢ=Zᵢ⁻∪Zᵢ⁺ and Xᵢ=Xᵢ⁻. In various aspects, M represents a regression function and S^{t} represents an optimization task that approximates M. For example, S^{t} can use linearization to approximate M. Thus, the local action surrogate model 618 can be formulated by [M(X,Z)]ₜ≈S^{t}(Z⁺) and provide feasible, optimal set points by imposing a penalty on S^{t}.

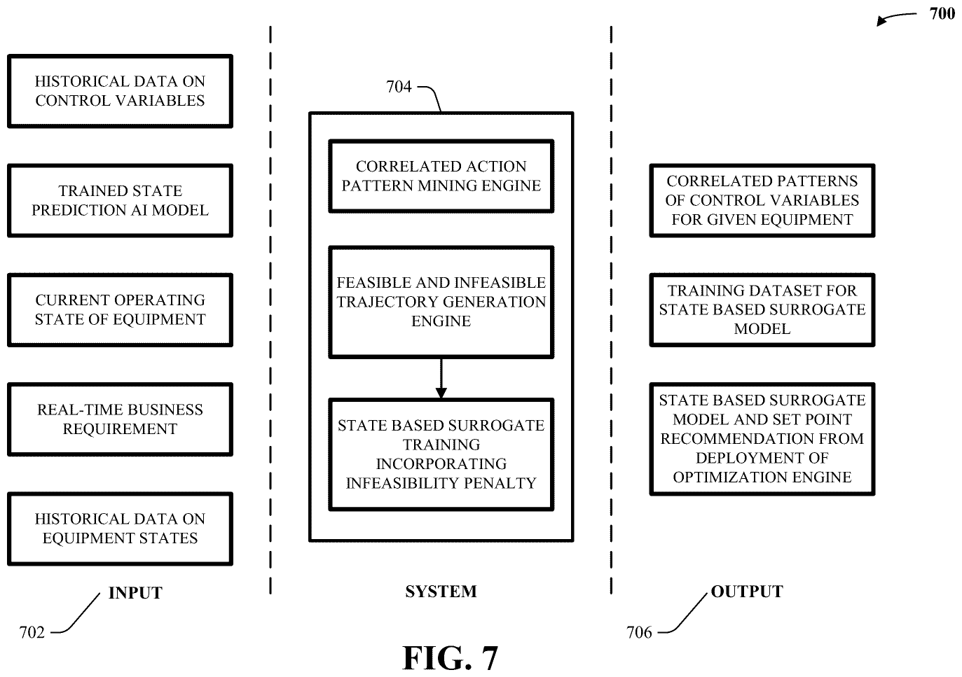

FIG. 7 illustrates a block diagram of an example, non-limiting system 700 that can facilitate tailored recommendation for process control in accordance with one or more embodiments described herein.

In various embodiments, system 100/200 can receive input 702. In various instances, input 702 can comprise historical data of control variables (e.g., control variables 504), historical data of equipment states (e.g., state variables 502), real-time business requirements, current operating equipment states (e.g., state variables 502), and a trained complex AI model for state prediction (e.g., complex AI model 516). System 100/200 can use such input data to generate output 706, wherein output 706 comprises learned correlated patterns of control variables and equipment states, a training dataset for a surrogate model (e.g., local action surrogate model 618), and the surrogate model to provide a set point recommendation.

In various embodiments, system 100/200 can utilize association rule mining to learn the correlated patterns of control variables and equipment states from input historical data. Thus, feasible and infeasible trajectories (e.g., compliant and non-compliant action profiles) can be generated. Furthermore, the trained complex AI model for state prediction can utilize the generated feasible and infeasible action trajectories as input to generate compliant and non-compliant system responses, wherein the system responses, feasible action trajectories, and an infeasible penalty function constitute the training dataset for the surrogate model. Thus, the trained surrogate model that includes the infeasible penalty function can be optimized to determine a recommendation of set points for control variables that are feasible and practical to implement.

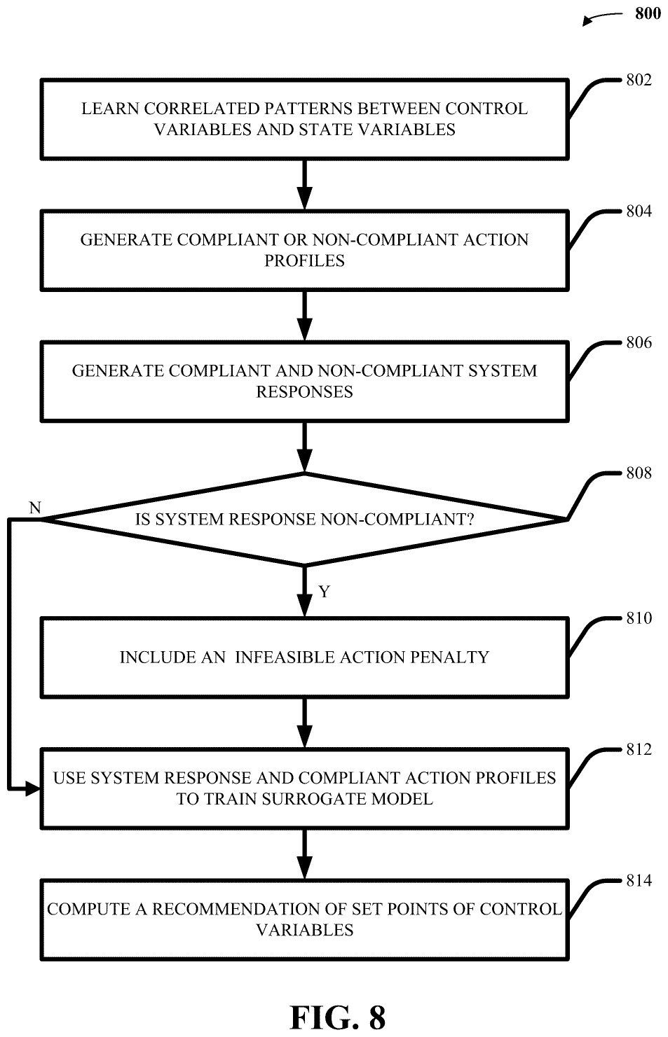

FIG. 8 illustrates a flow diagram of an example, non-limiting method 800 of facilitating tailored recommendation for process control in accordance with one or more embodiments described herein.

At 802, the non-limiting method 800 can comprise learning (e.g., by the learning component 202), by the system, correlated patterns between control variables and state variables.

At 804, the non-limiting method 800 can comprise removing (e.g., by the training component 110), by the system, compliant or non-compliant action profiles.

At 806, the non-limiting method 800 can comprise generating (e.g., by the training component 110), by the system, compliant and non-compliant system responses.

At 808, the non-limiting method 800 can determine if the system response is non-compliant. If yes (e.g., the system response is non-compliant), the non-limiting method 800 can proceed to 810. If no (e.g., the system response is compliant), the non-limiting method 800 can proceed to 812.

At 810, the non-limiting method 800 can comprise including (e.g., by the training component 110), by the system, an infeasible action penalty.

At 812, the non-limiting method 800 can comprise utilizing (e.g., by the training component 110), by the system, the system responses and compliant action profiles to train a surrogate model.

At 814, the non-limiting method 800 can comprise computing (e.g., by the analysis component 112), by the system, a recommendation of feasible and optimal set points of control variables.

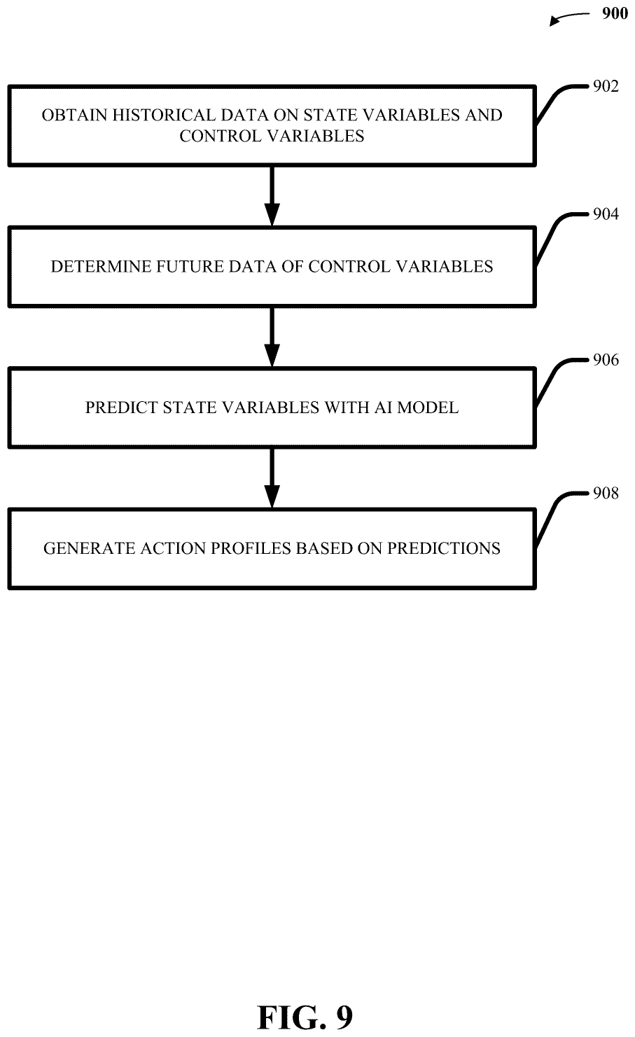

FIG. 9 illustrates a flow diagram of an example, non-limiting method 900 of facilitating tailored recommendation for process control in accordance with one or more embodiments described herein. Repetitive description of like elements and/or processes employed in respective embodiments is omitted for sake of brevity.

At 902, the non-limiting method 900 can comprise obtaining (e.g., by the learning component 202), by the system, historical data on state variables and control variables.

At 904, the non-limiting method 900 can comprise determining (e.g., by the learning component 202), by the system, future data of control variables.

At 906, the non-limiting method 900 can comprise predicting (e.g., by the learning component 202), by the system, state variables with a complex AI model.

At 908, the non-limiting method 900 can comprise generating (e.g., by the training component 110), by the system, action profiles based on the predictions.

For example, in an industrial process to manufacture steel, the learning component 202 can obtain historical data on control variables such as heat supply and amounts of raw materials used. Furthermore, the learning component 202 can obtain historical data on state variables such as equipment temperatures and steel temperature. Moreover, future data of control variables can be determined by a process operator that can manually manage the control variables (e.g., predetermined heat supply and amount of raw materials for the next 8 hours). Thus, the complex AI model can forecast or predict future state variable data (e.g., resulting equipment temperature or steel temperature from the determined control variables). Therefore, the training component 110 can use a VQ-VAE based generative model to learn correlated patterns and generate action profiles based on the forecasted state variables.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively perform surrogate model training with an infeasible action penalty as the one or more embodiments described herein can enable this process. And, neither can the human mind nor a human with pen and paper perform surrogate model training for a tailored recommendation of set points for process control, as conducted by one or more embodiments described herein.

FIG. 10 illustrates a block diagram of an example, non-limiting, operating environment in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as action profile generation code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 12. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the afore described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer-executable components stored in a non-transitory computer-readable memory, the computer-executable components comprising:
a training component that utilizes action trajectories to train a local action surrogate model that integrates an infeasible action penalty; and
an analysis component that employs the local action surrogate model in process control optimization formulation to provide a recommendation of set points.

2. The system of claim 1, further comprising a learning component that determines patterns of correlated actions using historical data of a set of control variables and real time operating constraints to generate the action trajectories.

3. The system of claim 1, wherein the training component simulates non-compliant action profiles to build the local action response model.

4. The system of claim 1, wherein the training component generates compliant action profiles to build the local action response model.

5. The system of claim 4, wherein the training component clusters discretized tokens of a multivariate time series and learns concurrence probability of patterns of tokens for a multi-variate signal to generate the compliant action profiles.

6. The system of claim 5, wherein the training component trains a vector quantized variational autoencoder generative model to generate a time series for set points of control variables.

7. The system of claim 5, wherein the training component trains an autoregressive prior model to generate a time series using ancestral sampling.

8. The system of claim 1, wherein the learning component generates feasible action trajectories or infeasible action trajectories to train the local action surrogate model.

9. The system of claim 1, wherein the learning component generates, from a global artificial intelligence model, a response to the action trajectories.

10. The system of claim 9, wherein the training component utilizes the response to the action trajectories to train the local action surrogate model.

11. A computer-implemented method, comprising:
utilizing, by the system, action trajectories to train a local action surrogate model that integrates an infeasible action penalty; and
employing, by the system, the local action surrogate model in process control optimization formulation to provide a recommendation of set points.

12. The computer-implemented method of claim 11, further comprising determining patterns of correlated actions using historical data of a set of control variables and real time operating constraints to generate the action trajectories.

13. The computer-implemented method of claim 11, further comprising simulating non-compliant action profiles to build the local action response model.

14. The computer-implemented method of claim 11, further comprising generating compliant action profiles to build the local action response model.

15. The computer-implemented method of claim 14, further comprising clustering discretized tokens of a multivariate time series and learning concurrence probability of patterns of tokens for a multi-variate signal to generate the compliant action profiles.

16. The computer-implemented method of claim 15, further comprising training a vector quantized variational autoencoder generative model to generate a time series for set points of control variables.

17. The computer-implemented method of claim 15, further comprising training an autoregressive prior model to generate a time series using ancestral sampling.

18. The computer-implemented method of claim 17, further comprising generating feasible action trajectories or infeasible action trajectories to train the local action surrogate model.

19. A computer program product comprising a non-transitory computer-readable memory having program instructions embodied therewith, the program instructions executable by a processor to cause the processor to:
utilize action trajectories to train a local action surrogate model that integrates an infeasible action penalty; and
employ the local action surrogate model in process control optimization formulation to provide a recommendation of set points.

20. The computer program product of claim 19, wherein the program instructions are further executable to cause the processor to:
determine patterns of correlated actions using historical data of a set of control variables and real time operating constraints to generate the action trajectories.
